(19) United States
(12) Patent Application Publication
(10) Pub. No.: US 2025/0330768 A1
(43) Pub. Date: Oct. 23, 2025

(54) AUDIO EFFECT ADJUSTMENT METHOD AND COMPUTING APPARATUS USED FOR AUDIO EFFECT ADJUSTMENT

(71) Applicant: Acer Incorporated, New Taipei City (TW)

(72) Inventors: Po-Jen Tu, New Taipei City (TW); Jia-Ren Chang, New Taipei City (TW); Liang-Chi Chen, New Taipei City (TW); Kai-Meng Tzeng, New Taipei City (TW); Feng-Ming Liu, New Taipei City (TW)

(73) Assignee: Acer Incorporated, New Taipei City (TW)

(21) Appl. No.: 18/815,848

(22) Filed: Aug. 27, 2024

(30) Foreign Application Priority Data
Apr. 19, 2024 (TW) 113114783

(51) Int. Cl. H04S 7/00; H04S 1/00

(52) U.S. Cl. CPC H04S 7/304; H04S 1/007; H04S 7/307; H04S 2400/11; H04S 2400/13; H04S 2420/01

(57) ABSTRACT

An audio effect adjustment method and a computing apparatus for audio effect adjustment are provided. A sound source direction corresponding to sound characteristics of a sound signal is determined. The sound characteristics are related to the amplitude and/or phase of 5 the sound signal recorded from a sound source located in the sound source direction. Posture changes of a head are determined. The posture changes include a rotation angle of the head from a first orientation to a second orientation. The head is used for wearing the sound playing apparatus. The sound characteristics of the sound signal are adjusted according to a direction difference between the sound source direction and the second orientation. The direction difference is an 10 angle between the sound source direction and the modified second orientation, as an orientation after the posture change from the sound source direction.

### CROSS-REFERENCE TO RELATED APPLICATION

This application claims the priority benefit of Taiwan application serial No. 113114783, filed on Apr. 19, 2024. The entirety of the above-mentioned patent application is hereby incorporated by reference herein and made a part of this specification.

### BACKGROUND

### Technical Field

The disclosure relates to a sound signal processing technology, and in particular to an audio effect adjustment method and a computing apparatus used for an audio effect adjustment.

### Description of Related Art

Spatial audio effects transfer sound signals to a surround sound field composed of multiple virtual speakers, adjust the response and delay of virtual sound signals from different directions, and transfer the sound signals into a three-dimensional sound field accordingly. It should be noted that the aforementioned spatial sound effect settings usually assume that the user is wearing headphones and the head of the user is facing the center of the computer screen. However, when the head is not facing the center of the screen, spatial audio effects are no longer applied to the aforementioned adjustments.

### SUMMARY

The disclosure provides an audio effect adjustment method and a computing apparatus used for audio effect adjustment, which are suitable for audio field adjustment with changes in head posture.

An audio effect adjustment method in an embodiment of the disclosure is adaptable for a processor implementation. The audio effect adjustment method includes: determining a sound source direction corresponding to sound characteristics of a sound signal, where the sound characteristics are related to at least one of an amplitude and a phase of the sound signal, and the sound signal is recorded from a sound source located in the sound source direction; determining posture changes of a head, where the posture changes include a rotation angle of the head from a first orientation to a second orientation, and the head is used for wearing a sound playing apparatus; and adjusting the sound characteristics of the sound signal according to a direction difference between the sound source direction and the second orientation, where the direction difference is an angle between the sound source direction and the modified second orientation, the modified second orientation is an orientation after the posture changes from the sound source direction, and the adjusted sound signal is used to be played by the sound playing apparatus.

The computing apparatus used for audio effect adjustment in the embodiment of the present invention includes a storage and a processor. A computing apparatus used for an audio effect adjustment in an embodiment of the disclosure includes a storage and a processor. The storage is used to store a program code. The processor is coupled to the storage. The storage is configured to: determine a sound source direction corresponding to sound characteristics of a sound signal, where the sound characteristics are related to at least one of an amplitude and a phase of the sound signal, and the sound signal is recorded from a sound source located in the sound source direction; determine posture changes of a head, where the posture changes include a rotation angle of the head from a first orientation to a second orientation, and the head is used for wearing a sound playing apparatus; and adjust the sound characteristics of the sound signal according to a direction difference between the sound source direction and the second orientation, where the direction difference is an angle between the sound source direction and the modified second orientation, the modified second orientation is an orientation after the posture changes from the sound source direction, and the adjusted sound signal is used to be played by the sound playing apparatus.

Based on the above, the audio effect adjustment method and the computing apparatus used for the audio effect adjustment according to the embodiments of the disclosure may use the sound source direction as the reference direction, the modified orientation is determined after the rotation of the head according to the reference direction, and the audio effect adjustment adaptable for the modified orientation is provided accordingly. Thereby appropriate spatial sound effect changes, and a more immersive listening experience is given to the user.

In order to make the aforementioned features and advantages of the disclosure comprehensible, embodiments accompanied with drawings are described in detail below.

### BRIEF DESCRIPTION OF THE DRAWINGS

FIG. 1A is a block diagram of elements of a system according to an embodiment of the disclosure.

FIG. 1B is a schematic diagram illustrating an application scenario according to an embodiment of the disclosure.

FIG. 2 is a flow chart of an audio effect adjustment method according to an embodiment of the disclosure.

FIG. 3A to FIG. 3C are schematic diagrams illustrating sound propagation paths according to an embodiment of the disclosure.

FIG. 4A is a schematic diagram illustrating an environment for sample collection according to an embodiment of the disclosure.

FIG. 4B is a schematic diagram illustrating model training and inference according to an embodiment of the disclosure.

FIG. 5 is a schematic diagram illustrating postures according to an embodiment of the disclosure.

FIG. 6A is a schematic diagram illustrating a first orientation and a sound source direction according to an embodiment of the disclosure.

FIG. 6B is a schematic diagram illustrating a first orientation, a second orientation, and a sound source direction according to an embodiment of the disclosure.

FIG. 7A to FIG. 7G are schematic diagrams illustrating parameters of multiple orientation equalizers according to an embodiment of the disclosure.

FIG. 8A and FIG. 8B are schematic diagrams illustrating parameters of equalizers of two channels according to an embodiment of the disclosure.

FIG. 9A is a frequency response diagram illustrating frequency responses of two channels at zero degrees according to an embodiment of the disclosure.

FIG. 9B is a frequency response diagram illustrating frequency responses of different monomers towards zero degree according to an embodiment of the disclosure.

FIG. 10A to FIG. 10F are frequency response diagrams illustrating a left channel at different angles according to an embodiment of the disclosure.

FIG. 11A to FIG. 11F are frequency response diagrams illustrating a right channel at different angles according to an embodiment of the disclosure.

### DESCRIPTION OF THE EMBODIMENTS

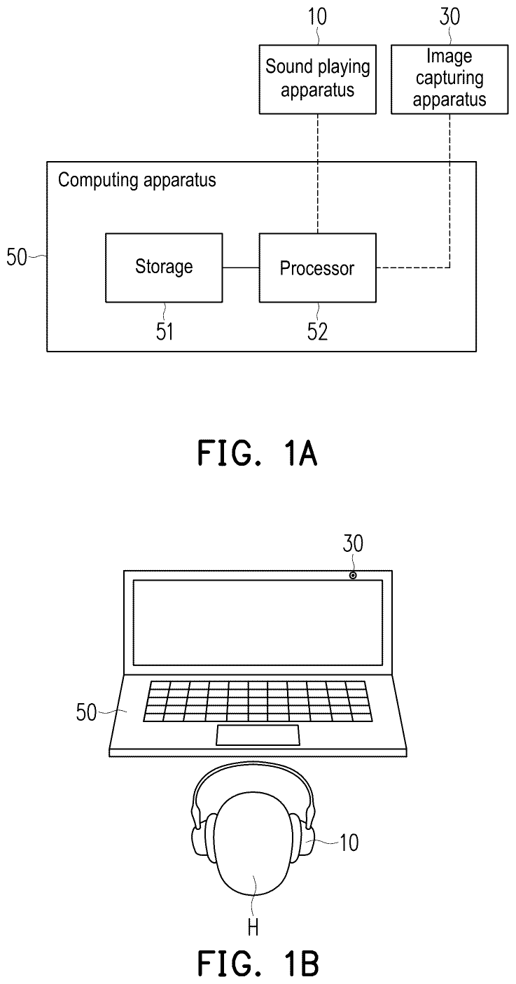

FIG. 1A is a block diagram of elements of a system according to an embodiment of the disclosure. Referring to FIG. 1A, a system includes a sound playing apparatus 10, an image capturing device 30, and a computing apparatus 50.

The sound playing apparatus 10 may be headphones or a wearable playing apparatus. FIG. 1B is a schematic diagram illustrating an application scenario according to an embodiment of the disclosure. Referring to FIG. 1B, the sound playing apparatus 10 can be worn on a head H of a user. A (in-ear or ear canal) speaker unit of the sound playing apparatus 10 may be towards the ears of the head H. In an embodiment, the sound playing apparatus 10 is used for playing sound signals.

The image capturing apparatus 30 may be a camera, a video camera, or a circuit with an image capturing function. Referring to FIG. 1B, the image capturing apparatus 30 is built-in or externally connected to the image capturing apparatus 30. A lens of the image capturing apparatus 30 may be towards the head H. In an embodiment, the image capturing apparatus 30 is used for capturing images. Taking FIG. 1B as an example, the image capturing apparatus 30 photographs the head and generates a head image (that is, capturing the image of the head H) accordingly.

The computing apparatus 50 may be a smartphone, a tablet computer, a desktop computer, a notebook computer, a smart assistant apparatus, a wearable apparatus, a smart TV, or other electronic apparatuses. The computing apparatus 50 is communicatively connected to the sound playing apparatus 10 and the image capturing apparatus 30. For example, the computing apparatus 50 is equipped with a universal serial bus (USB), a universal asynchronous receiver/transmitter (UART), or other wired transmission interfaces (not shown), or equipped with Wi-Fi, Bluetooth, or other wireless communication transceiver circuits (not shown), and transmits or receives signals accordingly. For example, the image capturing apparatus 30 transmits a signal carrying an image to the computing apparatus 50, or the computing apparatus 50 transmits a sound signal to the sound playing apparatus 10.

The computing apparatus 50 includes (but is not limited to) a storage 51 and a processor 52.

The storage 51 may be any type of a fixed or removable random access memory (RAM), a read only memory (ROM), a flash memory, a hard disk drive (HDD), a solid-state drive (SSD) or similar elements. In an embodiment, the storage 51 is used to store program codes, software modules, configurations, data (for example, sound signals, head images, or algorithm parameters), or files, and the embodiments are described in detail later.

The processor 52 is coupled to the storage 51. The processor 52 may be a central processing unit (CPU), a graphics processing unit (GPU), or other programmable microprocessors for a common purpose or a specific purpose, a digital signal processor (DSP), a programmable controller, a field programmable gate array (FPGA), an application-specific integrated circuit (ASIC), a neural network accelerator, or other similar elements or a combination of the above elements. In an embodiment, the processor 52 is used for executing all or part of operations of the computing apparatus 100, and may load and execute each program code, software module, file, and data stored in the storage 51. In an embodiment, the processor 52 may control the image capturing apparatus 30 to photograph images. In another embodiment, the processor 52 may control the playing functions of the sound playing apparatus 10 (for example, playing, pausing, switching tracks, fast forwarding, or rewinding). In some embodiments, the functions of the processor 52 may be implemented through software or a chip.

Regarding the application scenario, taking FIG. 1B as an example, the computing apparatus 50 is a notebook computer, and the head H faces a display of the notebook computer. However, there may be other changes in a position and/or an orientation of the user.

In the following, the method described in the embodiments of the disclosure is illustrated with reference to each element and module in the sound playing apparatus 10, the image capturing apparatus 30, and the computing apparatus 50. Each process of this method may be adjusted according to the implementation, but is not limited thereto.

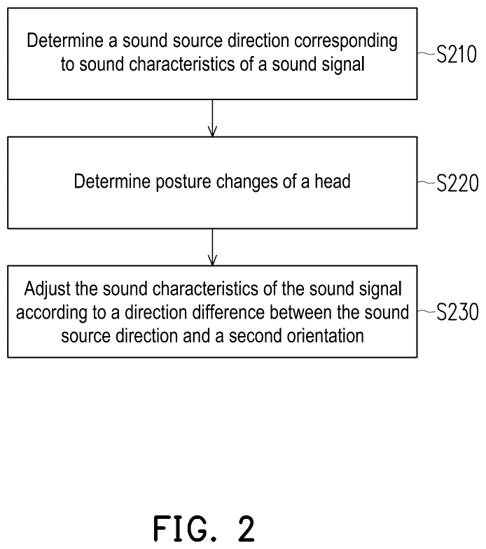

FIG. 2 is a flow chart of an audio effect adjustment method according to an embodiment of the disclosure. Referring to FIG. 2, the processor 52 determines the sound source direction (step S210) corresponding to the sound characteristics of the sound signal. Specifically, the sound signal is a signal that is expected to be sent to the sound playing apparatus 10 by the computing apparatus 50 and be played by the sound playing apparatus 10. The content of the sound signal may be music, speech, lecture, or broadcast, but is not limited thereto.

The sound characteristics are related to at least one of an amplitude and a phase of the sound signal. In an embodiment, the sound characteristics include frequency response. The frequency response is the response of the sound signal in a frequency domain, or may be a corresponding amplitude of the sound signal at multiple frequencies. The processor 52 may measure the frequency response of the sound signal. For example, the input impulse response is used to measure the response in the frequency domain, but is not limited thereto.

In an embodiment, the sound characteristics (further) include a signal delay. The signal delay is a time difference between the sound signals of two channels (for example, left and right channels). For example, a cross-correlation between the sound signals of two channels is calculated, and the delay amount (as the signal delay) is determined according to a peak value of a cross-correlation function.

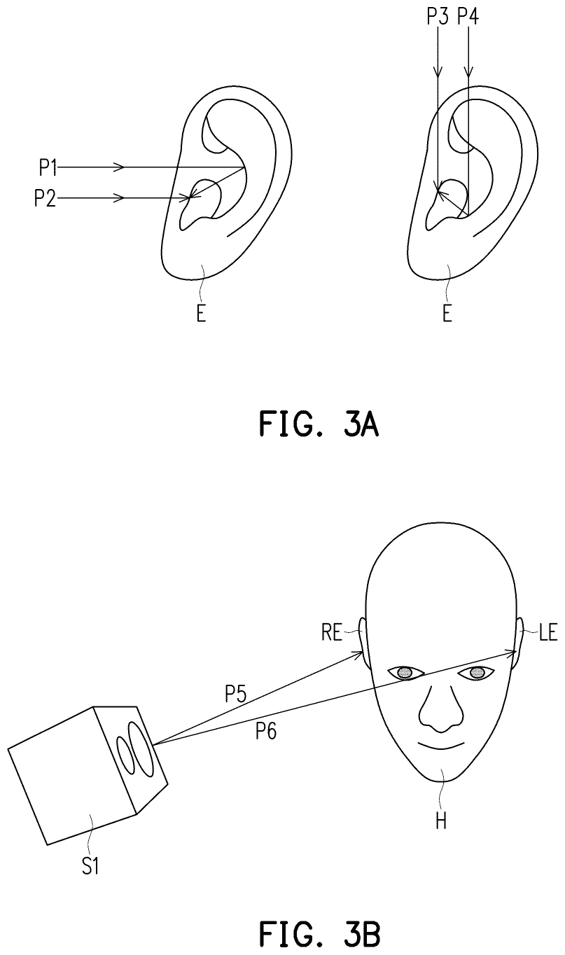

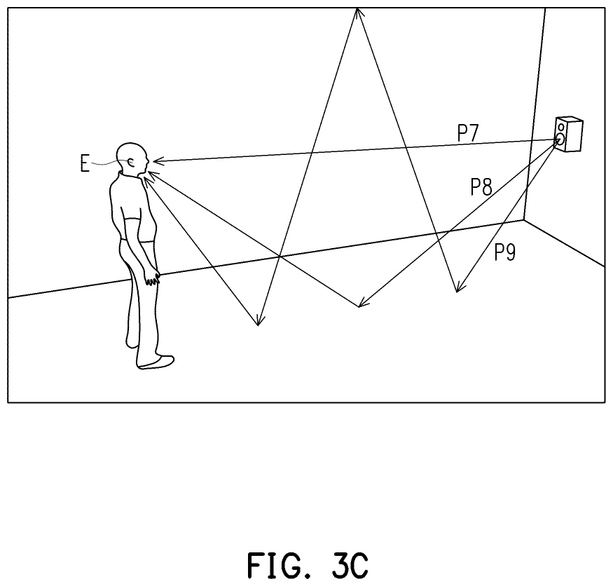

It should be noted that sound waves may be blocked or interfered by objects and form different propagation paths. For example, FIG. 3A to FIG. 3C are schematic diagrams illustrating sound propagation paths according to an embodiment of the disclosure. Referring to FIG. 3A, an auricle surface of an ear E includes multiple curved surfaces. Propagation paths P1 and P2 originate from far distances in a horizontal direction. However, the propagation path P1 may be reflected by the auricle to the ear canal. Alternatively, a propagation path P3 may directly enter the ear canal. The propagation paths P1 and P2 originate from the far distances in a vertical direction. However, the propagation path P3 may directly enter the ear canal. Alternatively, a propagation path P4 may be reflected by the auricle to the ear canal. The sound waves coming from different directions also have different distribution characteristics in frequency. The frequency response may reflect the above distribution characteristics. That is, the sound waves coming from different directions may correspond to different frequency responses, where the amplitude/intensity of the response at part of the frequency may be different.

In addition, referring to FIG. 3B, for the same sound source S1 (taking the speaker as an example), the sound signals directly reaching a left ear LE and a right ear RE respectively through different propagation paths P5 and P6 may be different, and the propagation times of the two propagation paths P5 and P6 may also be different. That is, the time when the sound signal originating from the sound source S1 directly reaching the left ear LE and the right ear RE may be different. Time differences in propagation/arrival times (that is, the signal delays) may affect the phase of the sound signal.

Referring to FIG. 3C, for the same sound source S1 (taking the speaker as an example), the sound signals respectively reaching the left ear LE and the right ear RE directly or through reflection through different propagation paths P7, P8 and P9 may be different. The propagation times of the three propagation paths P7, P8, and P9 may also be different. That is, the time when the sound signal originating from the sound source S1 reaches the left ear LE and the right ear RE directly or through reflection may be different. Time differences in propagation/arrival times (i.e., signal delays) may affect the phase of the sound signal. The sound waves coming from different directions may also correspond to different signal delays on the two channels.

In an embodiment, the sound signal is recorded from a sound source located in the sound source direction. That is, a microphone is located at a reference center, and the sound source direction is the direction of the sound source relative to the reference center. The sound source direction may include a horizontal direction and/or a vertical direction. The sound source may be people, musical instruments, animals, speakers, equipment, wind, or water, but is not limited thereto. For example, a person sings in front of a microphone, and the microphone records the human voice and generates a sound signal accordingly. The distance between the sound source and the reference center may be 20 cm, 50 cm, or 100 cm, but is not limited thereto.

In an embodiment, the processor 52 may analyze the sound characteristics of the sound signal, for example, the frequency responses and/or signal delays of the two channels. The sound signals coming from different directions have different frequency responses and/or different signal delays. The processor 52 may identify or estimate the sound direction according to the sound characteristics of the sound signal.

In an embodiment, the processor 52 may train a direction identification model through a machine learning algorithm, and thereby learn an association between the reference sound source located in multiple reference directions and the corresponding sound characteristics. The machine learning algorithm is, for example, a multiple layer perception (MLP), a convolutional neural network (CNN), a recurrent neural network (RNN), or a temporal convolutional network (TCN) (for example, Conv-TasNet), but is not limited thereto. The machine learning algorithm may train the direction identification model to understand labeled samples (for example, the sound characteristics of a determined reference direction) to establish the association between the sound signal/sound characteristics (that is, the input of the model) and the reference direction (that is, the output of the model). For example, CNN-based model training may obtain feature maps of labeled samples. The direction identification model is a model constructed after learning, and may be inferred based on the evaluation data (for example, the sound signal/sound characteristics to be evaluated) to determine the direction (as the sound source direction) corresponding to the signal to be evaluated. For example, the correct classification (as the sound source direction) is determined by a linear classifier.

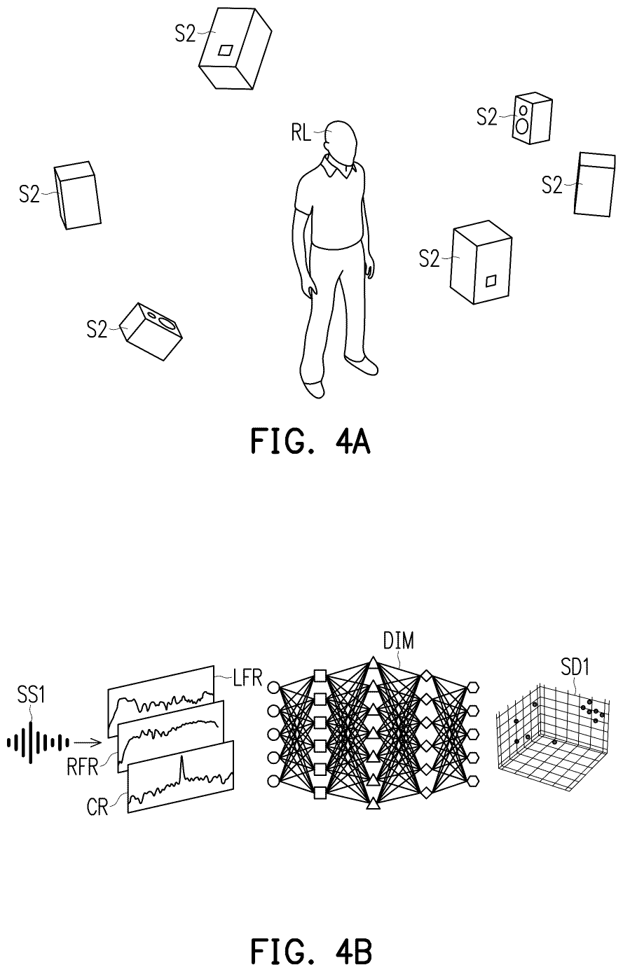

For example, FIG. 4A is a schematic diagram illustrating an environment for sample collection according to an embodiment of the disclosure. Referring to FIG. 4A, it is assumed that several speakers (as reference sound sources S2) are installed in the experimental space, and the relative directions (as the reference directions) of these reference sound sources S2 with respect to a head of a dummy RL are known. The reference directions may be predefined.

FIG. 4B is a schematic diagram illustrating model training and inference according to an embodiment of the disclosure. Referring to FIG. 4A and FIG. 4B, the ears of the dummy RL are respectively provided with microphones to receive a reference sound signal SS1. The reference sound signal SS1 is played through the reference sound source S2 respectively. The reference sound signal SS1 may be human voice, music, or synthetic sound, but is not limited thereto. The sound characteristics are captured from the reference sound signal SS1 received by the two microphones. For example, the two microphones correspond to the left and right channels respectively, and the sound characteristics are the frequency responses LFR, RFR and/or a signal delay CR between the two reference sound signals SS1 received by the two microphones respectively. The sound characteristics of the reference sound signal SS1 and the reference direction corresponding to the reference sound source S2 are used as training samples for a direction identification model DIM. The sound characteristics of the reference sound source S2 corresponding to other reference directions and the reference direction may also be used as other training samples. These training samples are used to train the direction identification model DIM.

The processor 52 may train the direction identification model DIM or obtain the trained direction identification model DIM from other apparatuses. Next, the processor 52 may input the sound characteristics of the sound signal to the direction identification model DIM, and determine an sound source direction SD1 corresponding to the sound characteristics by the direction identification model DIM. The output of the direction identification model DIM may be a specific direction (for example, 30, 45, or 90 degrees, but not limited thereto) (directly used as the sound source direction SD1), or may be the probability corresponding to the reference directions (the arithmetic average of the one with the highest probability is used as the sound source direction SD1).

In another embodiment, the association between the positions of the reference directions and the corresponding sound characteristics may be recorded as a comparison table or converted into an equation. The processor 52 may determine the sound source direction corresponding to the sound characteristics of the sound signal by looking up the comparison table or using the equation.

Referring to FIG. 2, the processor 52 determines the posture changes of the head (step S220). Specifically, the head is used for wearing the sound playing apparatus 10. As shown in FIG. 1B, over-ear headphones (that is, an example of the sound playing apparatus 10) is worn on the head H. Rotation of the head causes posture changes. The posture changes include a rotation angle of the head from the first orientation to the second orientation. For example, the head at time point t faces the first orientation, and the head at time point t+1 faces the second orientation.

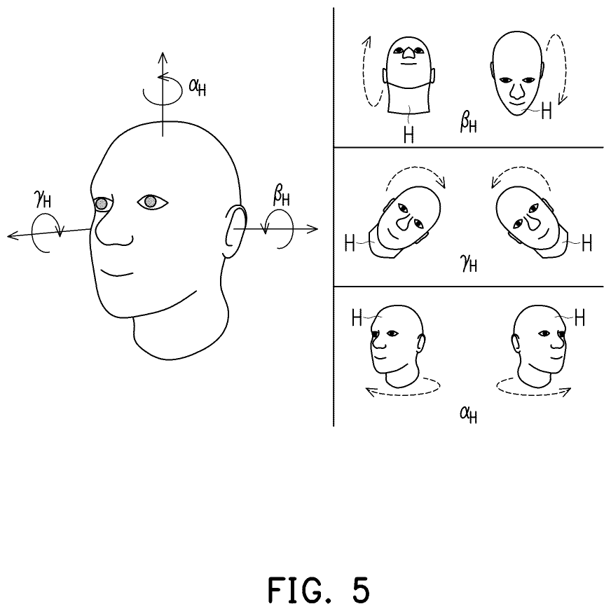

FIG. 5 is a schematic diagram illustrating postures according to an embodiment of the disclosure. Referring to FIG. 5, the rotation angle of the head H includes a yaw angle α_{H}, a pitch angle β_{H}, and a roll angle γ_{H}.

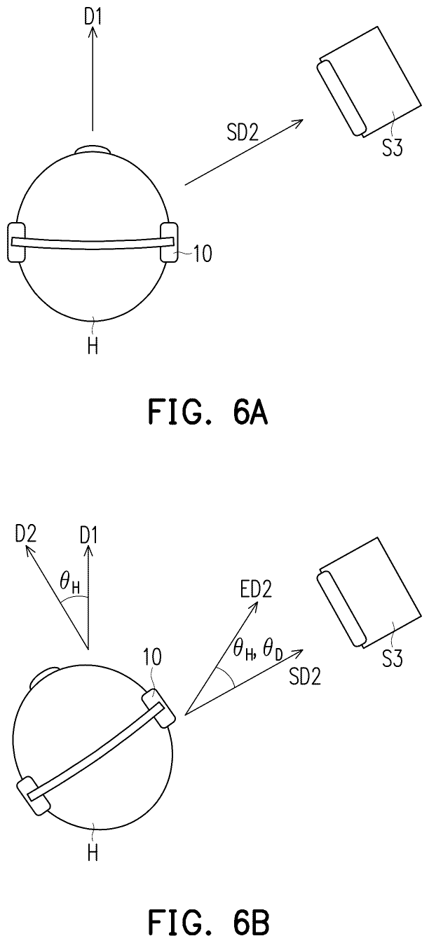

FIG. 6A is a schematic diagram illustrating a first orientation and a sound source direction according to an embodiment of the disclosure. Referring to FIG. 6A, a front of the head wearing the sound playing apparatus 10 is towards the first orientation D1. The sound source direction SD2 is a direction of a sound source S3 relative to a recording position (such as the aforementioned reference center) (for example, the left channel corresponds to 30 degrees; the right channel is 180 degrees different from the left channel, and the right channel corresponds to −30 degrees).

FIG. 6B is a schematic diagram illustrating the first orientation D1, the second orientation D2, and the sound source direction SD2 according to an embodiment of the disclosure. Referring to FIG. 6B, it is assumed that a rotation angle θ_{H} corresponding to the posture change of the head H is the yaw angle α_{H} of 20 degrees (for example, the left channel corresponds to 20 degrees; the right channel is 180 degrees different from the left channel, and the right channel corresponds to −20 degrees). At this time, the front of the head H faces the second orientation D2.

In an embodiment, the processor 52 may identify posture changes according to the head image. The processor 52 may photograph the head by the image capturing apparatus 30 and capture the head image accordingly. As shown in FIG. 1B, the head H is located in front of the image capturing apparatus 30, and a lens field of view of the image capturing apparatus 30 covers the head H. The image characteristics of the head image may be used to identify the posture changes. The image characteristics are, for example, histogram of oriented gradient (HOG), scale-invariant feature transform (SIFT), Harr, or speeded up robust features (SURF). The image characteristics may also be the feature maps captured by the machine learning models.

The head image is an image captured by rotating the head from the first orientation to the second orientation. As shown in FIG. 6A, the image capturing apparatus 30 may continuously capture the head images from the posture of the head H facing the first orientation D1 to the posture of the head H facing the second orientation D2 as shown in FIG. 6B. The frequency of image capturing may be 24, 30, or 60 images per second, but is not limited thereto. The image capturing apparatus 30 may also trigger the image capturing function based on predetermined conditions (for example, user operation or sound).

The processor 52 may identify a face of the head image. The recognition may be based on an object detection technology. For example, the processor 52 may apply neural network based algorithms (for example, YOLO (you only look once)), region based convolutional neural networks (R-CNN), or Fast R-CNN, or feature matching-based algorithms (for example, the feature comparison of the HOG, the SIFT, the Harr, or the SURF) to achieve object detection.

The processor 52 may also identify facial parts (for example, eyes, a mouth, or a nose) of the head image. When the lens of the image capturing apparatus 30 is fixed, the head may not be able to capture all the facial parts in some postures.

The processor 52 may define feature points for the head image. For example, the feature points are located at the corner of the mouth, the tip of the nose, the upper edge of the ears, or the eyes, but are not limited to thereto. The processor 52 may track the position of one or more feature points of multiple consecutive head images. The posture changes in the head are reflected in changes in the positions of these feature points. For example,

$${α}_{H} = ar tan ( \frac{{RP}_{L - eye - y} - {RP}_{R - eye - y}}{{RP}_{L - eye - x} - {RP}_{R - eye - x}} ) \qquad ( 1 )$$

$${β}_{H} = {RP}_{nose - x}^{′} - {RP}_{nose - x} \qquad ( 2 )$$

$${γ}_{H} = {RP}_{nose - y} - {RP}_{nose - y}^{′} \qquad ( 3 )$$

RP_{L-eye-y} is a position of a left eye feature point on a vertical axis of the head image.
RP_{R-eye-y} is a position of a right eye feature point on the vertical axis of the head image.
RP_{L-eye-x} is a position of the left eye feature point on a horizontal axis of the head image.
RP_{R-eye-x} is a position of the right eye feature point on the horizontal axis of the head image.
RP′ₙₒₛₑ₋ₓ is a position of a nose feature point on the horizontal axis of the head image when the head is in the second orientation. RPₙₒₛₑ₋ₓ is a position of the nose feature point on the horizontal axis of the head image when the head is in the first orientation. RP′_{nose-y} is a position of the nose feature point on the vertical axis of the head image when the head is in the second orientation. RP_{nose-y} is a position of the nose feature point on the vertical axis of the head image when the head is in the first orientation.

In other embodiments, the processor 52 may also apply neural network-based algorithms (for example, YOLO, the R-CNN, or the fast R-CNN, or feature matching-based algorithms (for example, the feature comparison of the HOG, the SIFT, the Harr, or the SURF) to achieve posture identification. For example, the neural network is trained to learn the correlation between multiple reference postures/rotation angles and image characteristics. For another example, a comparison table records the association between the reference postures/the rotation angles and the image characteristics. For another example, the transformation function records the association between the reference postures/the rotation angles and the image characteristics.

In another embodiment, the sound playing apparatus 10 is provided with a motion sensor (for example, a gyroscope, an accelerometer, or an inertial detection unit). Sensing data from motion sensors may be used for analyzing the posture changes.

Referring to FIG. 2, the processor 52 adjusts the sound characteristics of the sound signal according to the direction difference between the sound source direction and the second orientation (step S230). Specifically, the direction difference is an angle between the sound source direction and the modified second orientation (that is, the rotation angle corresponding to the posture change, or an angle between the first orientation and the second orientation), and the modified second orientation is an orientation of the sound source direction after the posture changes. It should be noted that compared with a traditional spatial sound effect setting that the direction of the head towards a center of a computer screen is used as the sound source direction, the actual position of the sound source of the sound signal, however, is not necessarily directly in front of the reference center. Therefore, the initial orientation of the posture change should be modified to the sound source direction.

Taking FIG. 6B as an example, the rotation angle from the first orientation D1 to the second orientation is θ_{H} (for example, including the yaw angle α_{H}, the pitch angle β_{H}, and the roll angle γ_{H}). The initial orientation is modified to the sound source direction SD2. The rotation angle θ_{H} from the sound source direction SD2 is the modified second orientation ED2. It is assumed that the rotation angle θ_{H} is 20 degrees (corresponding to the left channel, and the right channel corresponds to −20 degrees), and the sound source direction is 30 degrees (corresponding to the left channel, and the right channel corresponds to −30 degrees). Therefore, the modified second orientation ED2 is 10 degrees (that is, 30 degrees−20 degrees). In addition, an angle between the modified second orientation ED2 and the sound source direction SD2 (that is, the direction difference θ_{D}) is the same as the rotation angle θ_{H}.

In an embodiment, the processor 52 may dispose corresponding spatial audio effects for multiple orientations of the head. In an embodiment, the processor 52 may set spatial audio effects or other audio effects by an equalizer. The parameters of the equalizer may have corresponding gains/powers (used to increase or decrease the response of the corresponding frequencies/frequency bands) at multiple frequencies/frequency bands. Different parameters may be disposed in different orientations and configured to provide the spatial audio effects or other audio effects. Taking the spatial audio effects as an example, the processor 52 may transfer the sound signals of the two channels to a surround sound field with multiple virtual speakers, adjust the frequency response and/or phase from different directions based on a head related transfer functions (HRTF) theory, and then transfer the adjusted sound signal back to stereo sound field signals of the two channels.

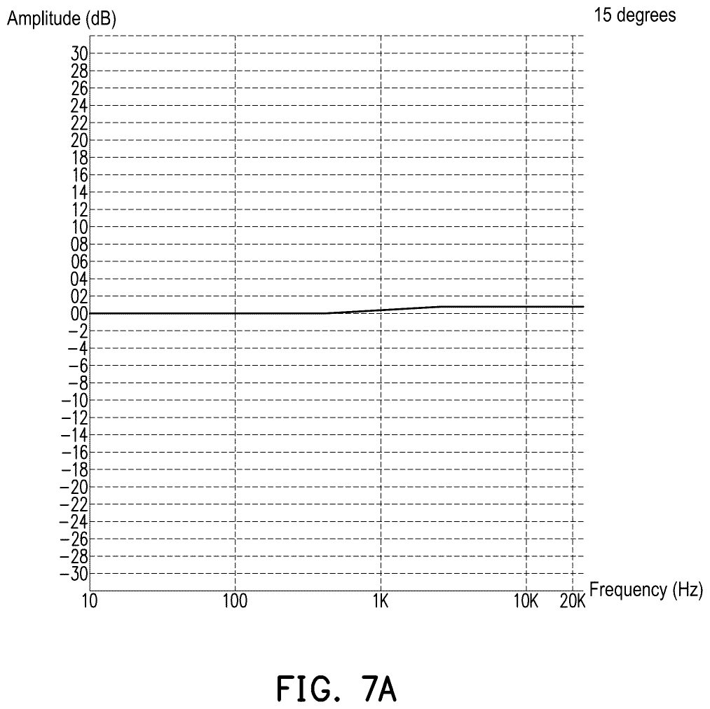

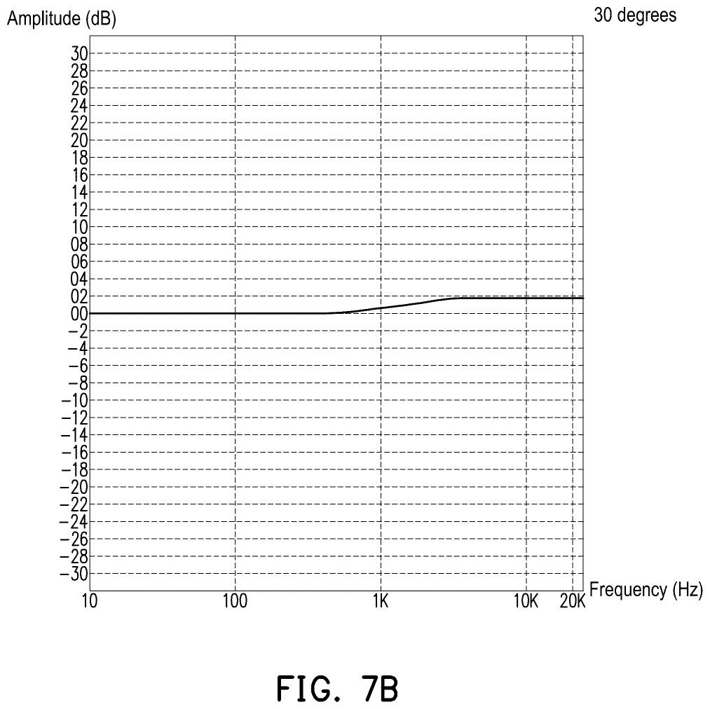

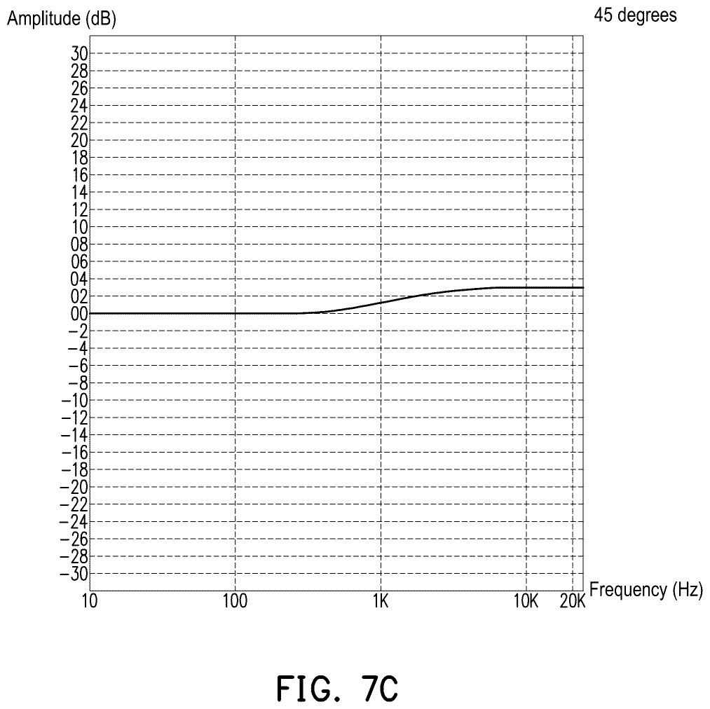

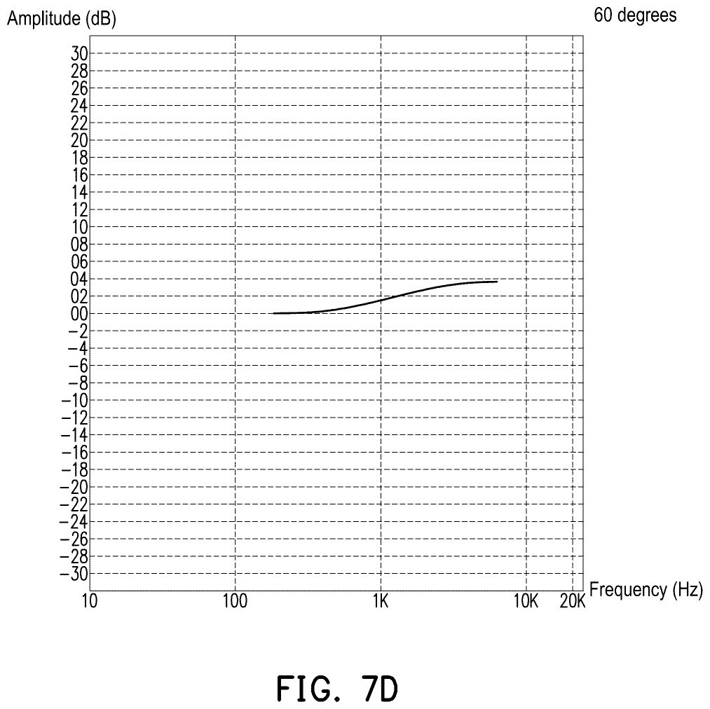

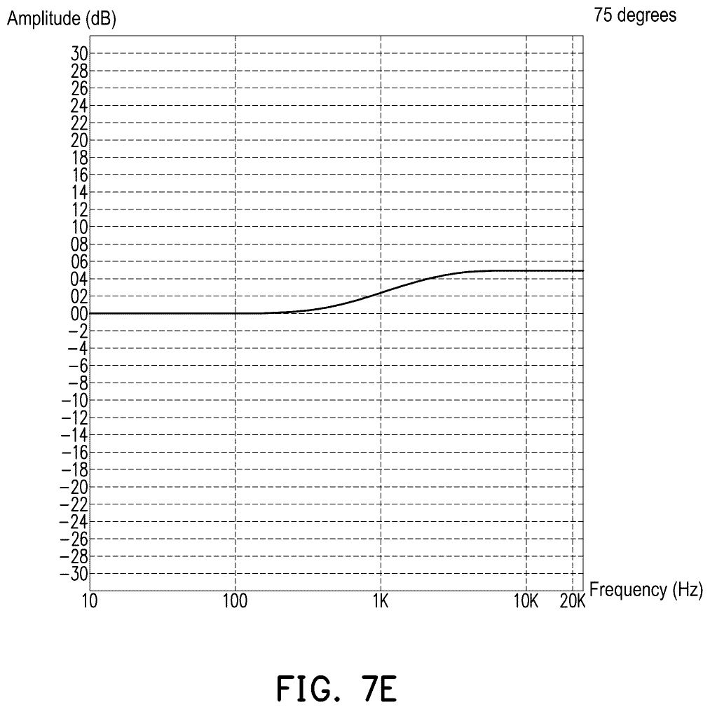

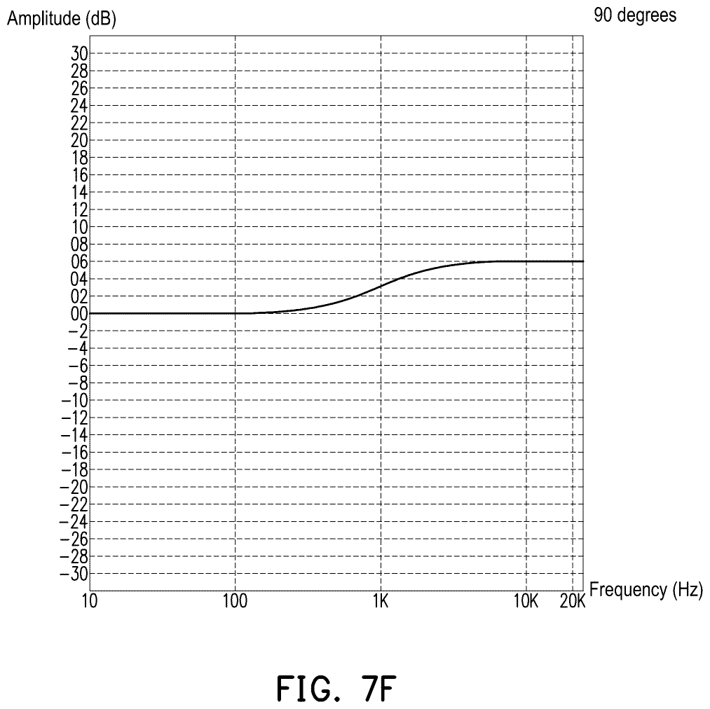

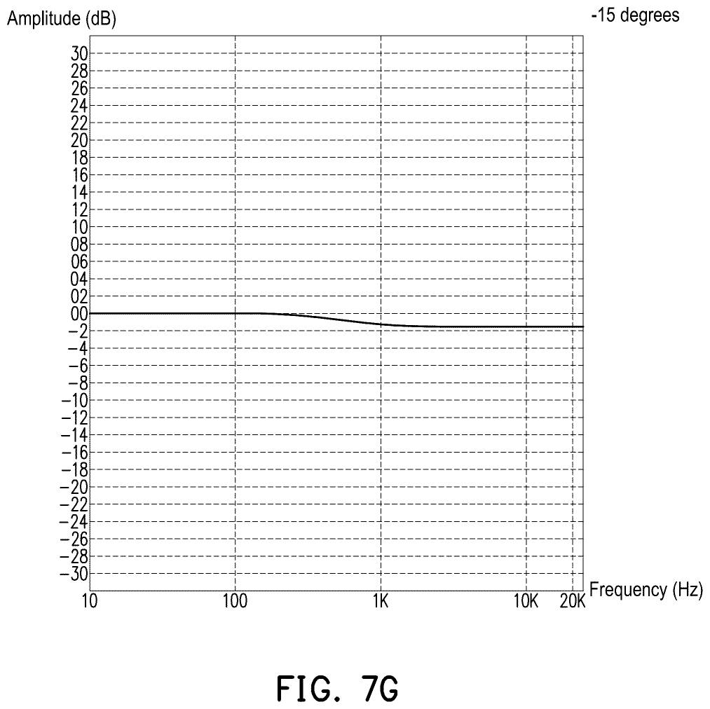

For example, FIG. 7A to FIG. 7G are schematic diagrams illustrating parameters of multiple orientation equalizers according to an embodiment of the disclosure. Please refer to FIG. 7A to FIG. 7G, which are the parameters of the equalizer for head orientations of 15 degrees, 30 degrees, 45 degrees, 60 degrees, 75 degrees, 90 degrees, and −15 degrees respectively. Taking FIG. 7A and FIG. 7F as an example, compared to a parameter with an orientation of 15 degrees, a parameter with an orientation of 90 degrees has a higher gain/power (that is, the amplitude is larger) in a high frequency band (for example, frequency is 1 K to 20 K Hz).

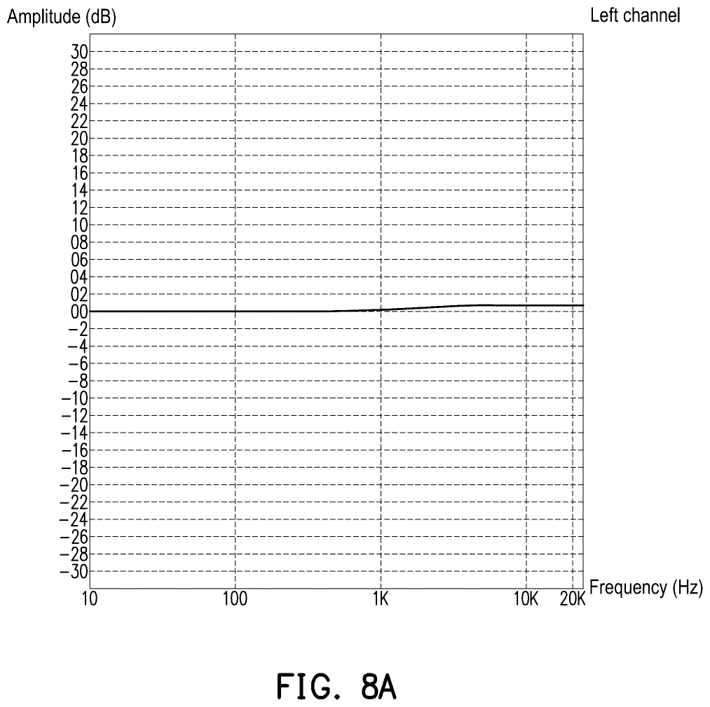

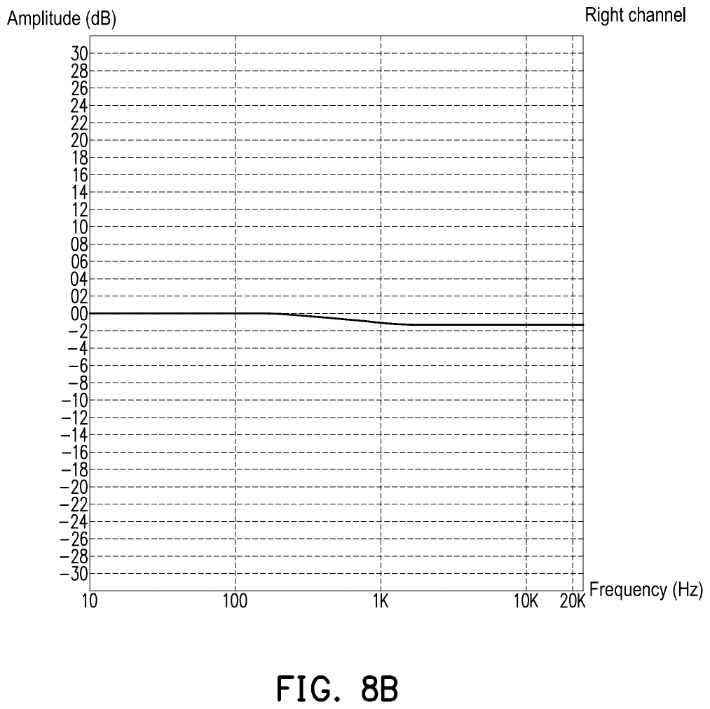

FIG. 8A and FIG. 8B are schematic diagrams illustrating parameters of equalizers of two channels according to an embodiment of the disclosure. Please refer to FIG. 8A and FIG. 8B. FIG. 8A shows the parameters of the left channel, and FIG. 8B shows the parameters of the right channel. In an embodiment, in response to an increase in a parameter (for example, gain/power) of the left channel at a certain frequency/frequency band, the processor 52 may decrease a parameter of the right channel at the same frequency/frequency band. Alternatively, in response to a decrease in a parameter (for example, gain/power) of the left channel at a certain frequency/frequency band, the processor 52 may increase a parameter of the right channel at the same frequency/frequency band. In another embodiment, in response to an increase in a parameter (for example, gain/power) of the right channel at a certain frequency/band, the processor 52 may decrease a parameter of the left channel at the same frequency/frequency band. Alternatively, in response to a decrease in a parameter (for example, gain/power) of the right channel at a certain frequency/frequency band, the processor 52 may increase a parameter of the left channel at the same frequency/frequency band. The equalizers of the two channels compensate for each other to maintain overall power and keep soundstage balance. For example, when the head turns left, the power of the left channel increases and the power of the right channel decreases; when the head turns right, the power of the right channel increases and the power of the left channel decreases.

It should be noted that the parameters shown in FIG. 7A to FIG. 7F, FIG. 8A and FIG. 8B are only examples, and the values of the parameters may still be adjusted according to actual needs.

In an embodiment, the processor 52 may adjust the frequency response of the sound signal by a first parameter of the equalizer. The sound source direction corresponds to a second parameter of the equalizer, and the modified second orientation corresponds to a third parameter of the equalizer. The first parameter, the second parameter, and the third parameter have corresponding gains/powers in one or more frequencies/frequency bands. As shown in FIG. 7A to FIG. 7F, FIG. 8A and FIG. 8B, different parameters may be disposed in different orientations.

The first parameter is a gain/power difference between the second parameter and the third parameter in the frequencies/frequency bands. Mathematical expressions are taken as an example:

$${Δφ}^{L} ( f ) = φ ( {θ}_{S}^{L} - {θ}_{H}^{L} , f ) - φ ( {θ}_{S}^{L} , f ) \qquad ( 4 )$$

$${Δφ}^{R} ( f ) = φ ( {θ}_{S}^{R} - {θ}_{H}^{R} , f ) - φ ( {θ}_{S}^{R} , f ) \qquad ( 5 )$$

Δφ^{L}(f) and Δφ^{R}(f) are the first parameters of the left and right channels at frequency f respectively,

$$φ ( {θ}_{S}^{L} , f ) and ϕ ( {θ}_{S}^{R} , f )$$

are the second parameters of the left and right channels at frequency f for the sound source direction (the left channel corresponds to

$${θ}_{S}^{L} ,$$

the right channel corresponds to

$${θ}_{S}^{R} )$$

respectively,

$$φ ( {θ}_{S}^{L} - {θ}_{H}^{L} , f ) and φ ( {θ}_{S}^{R} - {θ}_{H}^{R} , f )$$

are the three parameters of the left and right channels at frequency f for the modified second orientation (the rotation angle of the left channel corresponds to

$${θ}_{H}^{L} ,$$

and the right channel corresponds to

$${θ}_{H}^{R} )$$

respectively.

Taking FIG. 7A and FIG. 7C as an example, it is assumed that the rotation angle

$${θ}_{H}^{L}$$

corresponding to the left channel is 30 degrees (rotation from 15 degrees to 45 degrees). The parameter of FIG. 7A for 15 degrees is the second parameter, and the parameter of FIG. 7C for 45 degrees is the third parameter. Therefore, the first parameter is the gain/power difference between the second parameter of FIG. 7A and the third parameter of FIG. 7C at one or more frequencies/frequency bands.

Taking FIG. 7A to FIG. 7D and FIG. 7G as an example, it is assumed that the rotation angle θ_{H} of the head is 15 degrees, and the sound source direction θ_{S} is 30 degrees or 60 degrees. Regarding the existing technology, without considering the sound source direction θ_{S}, the power adjustment parameters of the equalizer adopt the parameters for the orientation of −15 degree shown in FIG. 7G. However, in the embodiment of the disclosure, if the sound source direction θ_{S} is 30 degrees, the power adjustment parameters of the equalizer are based on the gain/power difference between the parameters for the orientation of 30 degrees shown in FIG. 7B and the orientation of 15 degrees (that is, the gain/power difference between the parameters of the modified second orientation) shown in FIG. 7A; if the sound source direction θ_{S} is 60 degrees, the power adjustment parameters of the equalizer are based on the gain/power difference between the parameters for the orientation of 60 degrees shown in FIG. 7D and the parameters for the orientation of 45 degrees (that is, the modified second orientation) shown in FIG. 7C. The parameters of the equalizer used in the embodiments of the disclosure are different from those used in the related art.

In an embodiment, the processor 52 may adjust the signal delay of the sound signals of the two channels to a modified delay. This modified delay is the difference between a first delay and a second delay. The sound source direction corresponds to the first delay, and the modified second orientation corresponds to the second delay. A mathematical expression is taken as an example:

$$Δ τ = τ ( {θ}_{S} - {θ}_{H} ) - τ ( {θ}_{S} ) \qquad ( 6 )$$

Δτ is the modified delay, τ(θ_{S}) is the first delay corresponding to the sound source direction θ_{S}, and τ(θ_{S}−θ_{H}) is the modified second orientation corresponding to the second delay of the modified second orientation (the modified second orientation is from the sound source direction θ_{S} by the rotation angle θ_{H}). The processor 52 may delay at least one of the sound signals of the two channels, so that the signal delay of the sound signals of the two channels is the same as the modified delay. For example, the sound signal is delayed by a buffer or a delay circuit.

The adjusted sound signal (with spatial or other audio effects corresponding to the modified second orientation) is used to be played by the sound playing apparatus 10. For example, the computing apparatus 50 transmits the adjusted sound signal to the sound playing apparatus 10. The sound playing apparatus 10 may play the adjusted sound signal.

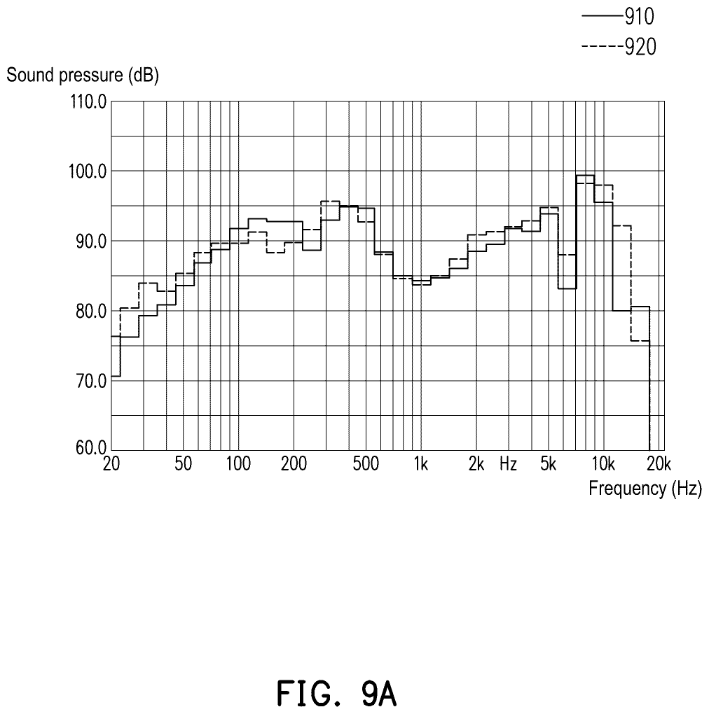

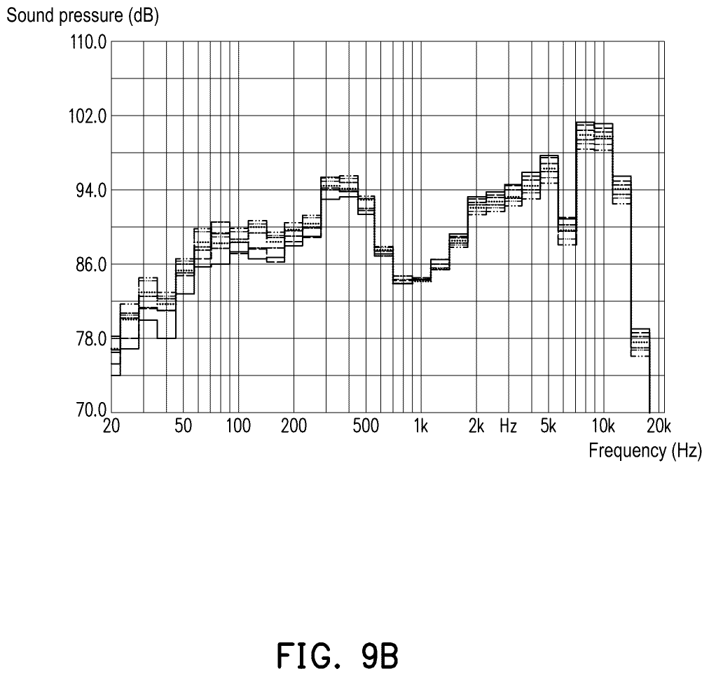

FIG. 9A is a frequency response diagram illustrating frequency responses of two channels at zero degrees according to an embodiment of the disclosure. Referring to FIG. 9A, it has been experimentally proved that corresponding sound effect settings are provided for the sound signals of the two channels. Although there is a difference between a frequency response 910 of the left channel and a frequency response 920 of the right channel, the frequency responses are both within the acceptable range.

FIG. 9B is a frequency response diagram illustrating frequency responses of different monomers towards zero degree according to an embodiment of the disclosure. Referring to FIG. 9B, it has been experimentally proved that even if different monomers or different wearing forms (corresponding to different solid or dotted line segments in the figure) are used, the differences in these frequency responses are still within the acceptable range.

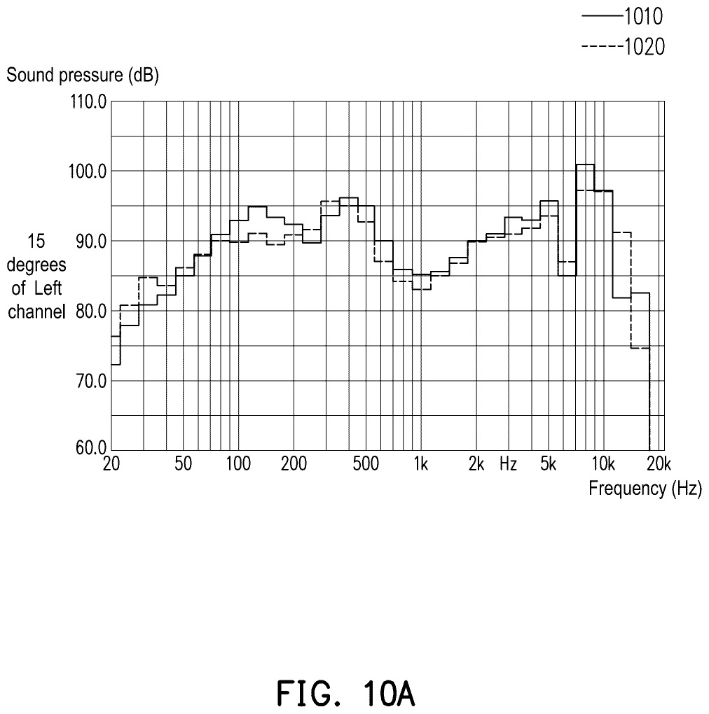

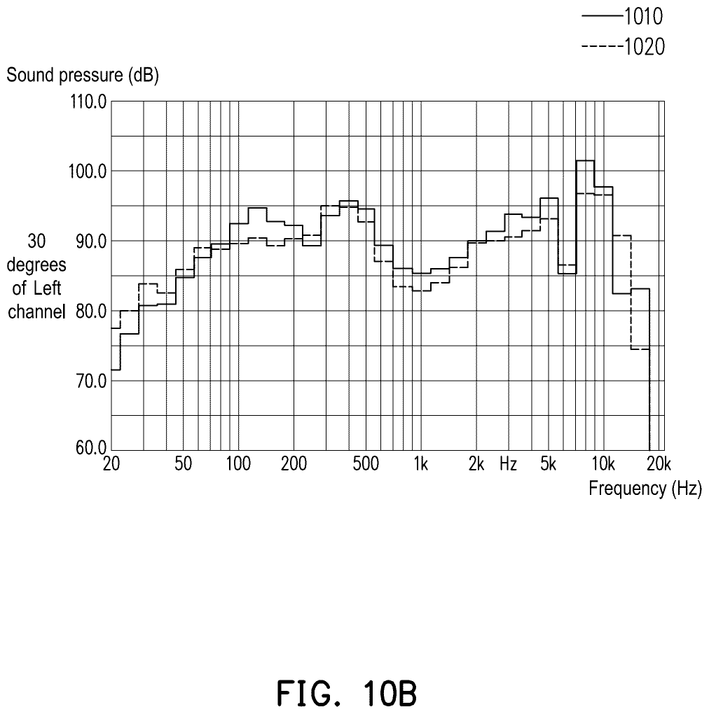

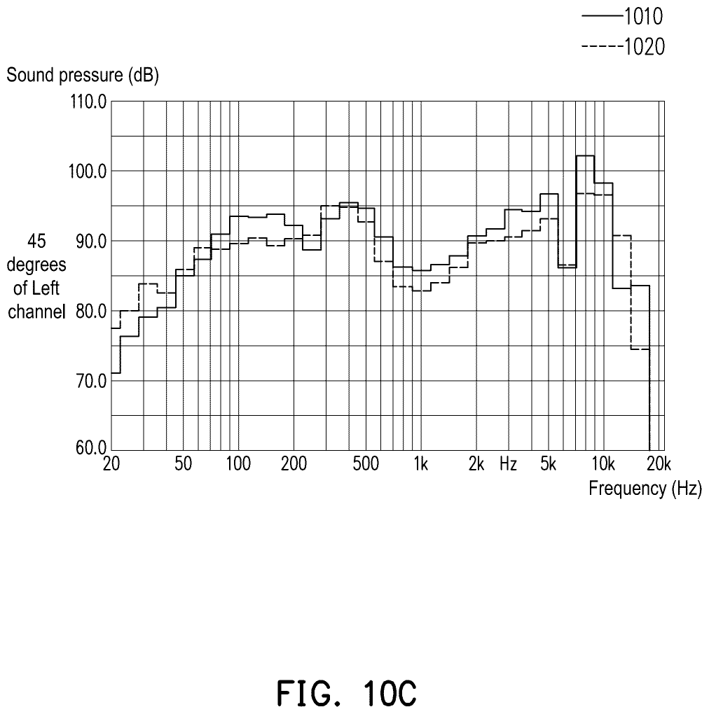

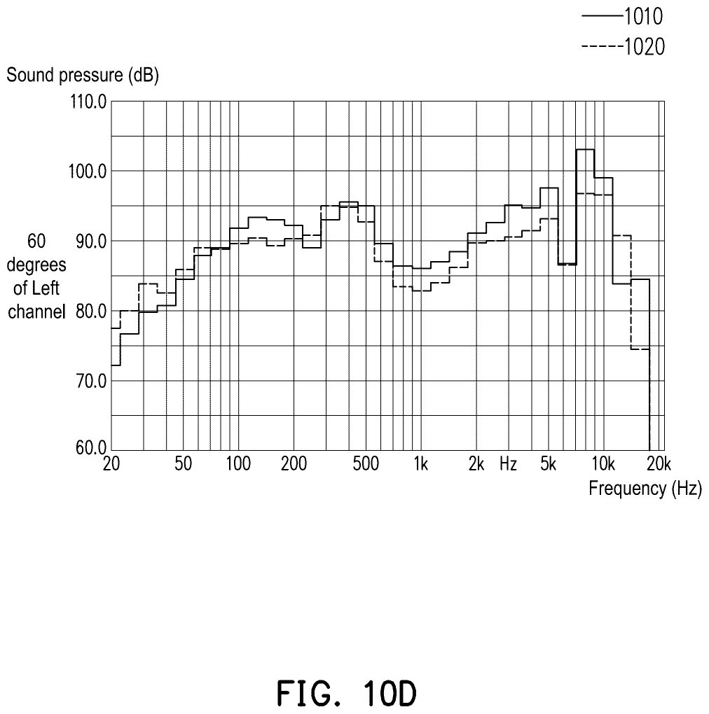

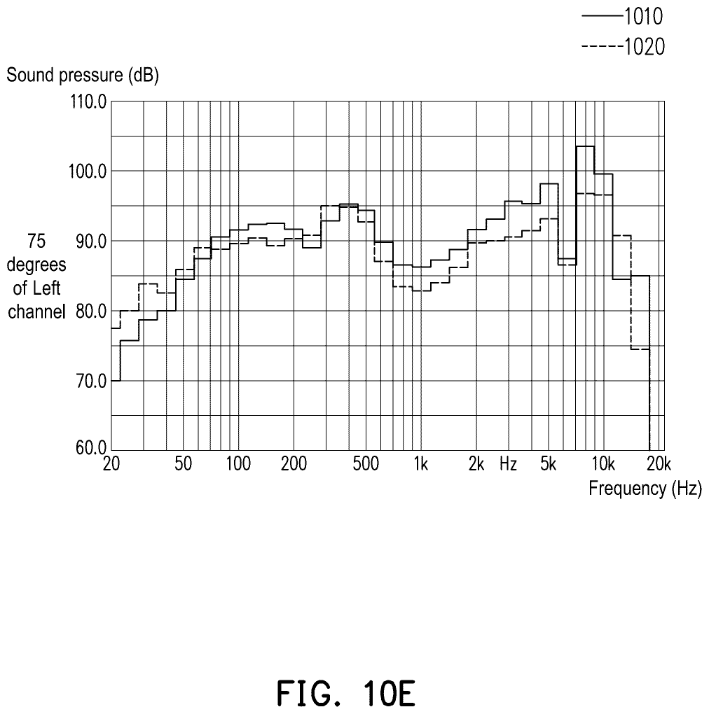

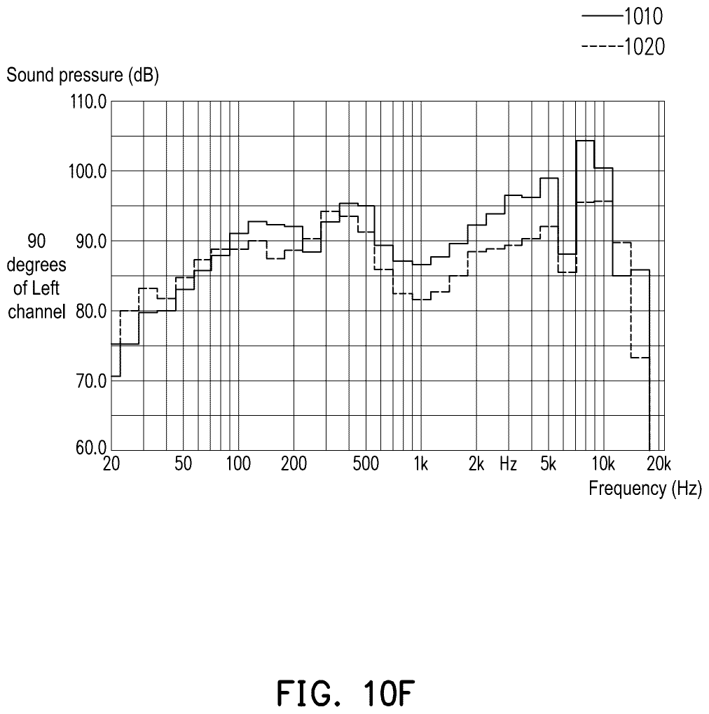

FIG. 10A to FIG. 10F are frequency response diagrams illustrating a left channel at different angles according to an embodiment of the disclosure. Please refer to FIG. 10A to FIG. 10F, which are the frequency response 1010 (the same as the frequency response 910 in FIG. 9A) when the orientation of the head is 0 degrees and the frequency response 1020 of the adjusted sound signal for the left channel when the orientations of the head are 15 degrees, 30 degrees, 45 degrees, 60 degrees, 75 degrees, and 90 degrees respectively.

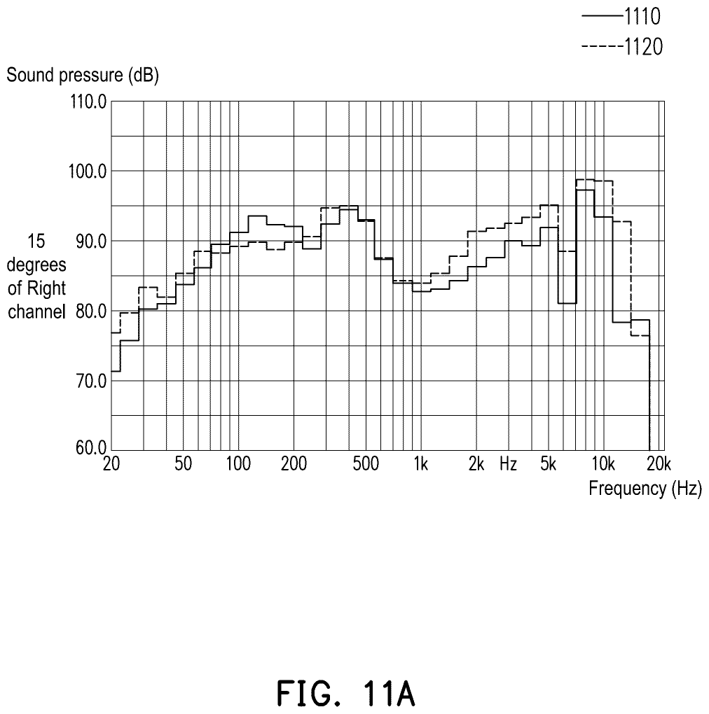

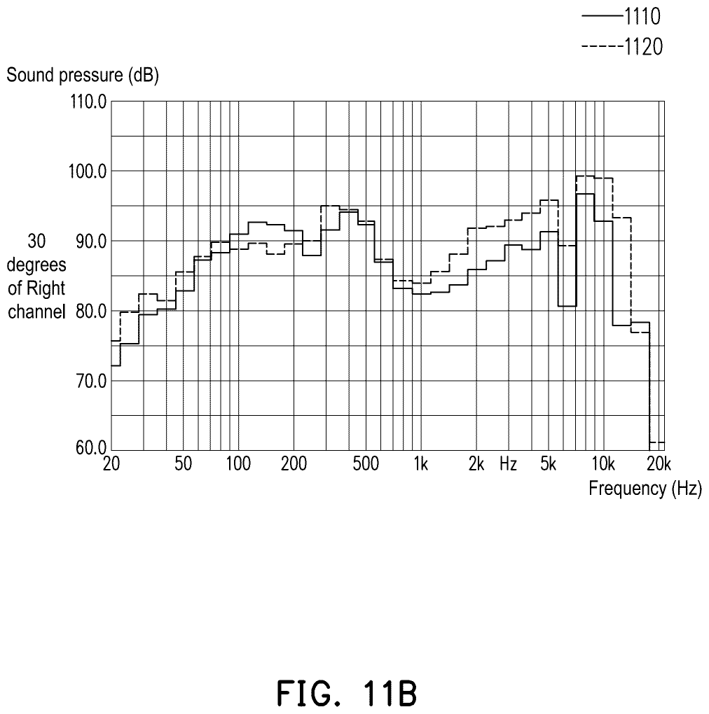

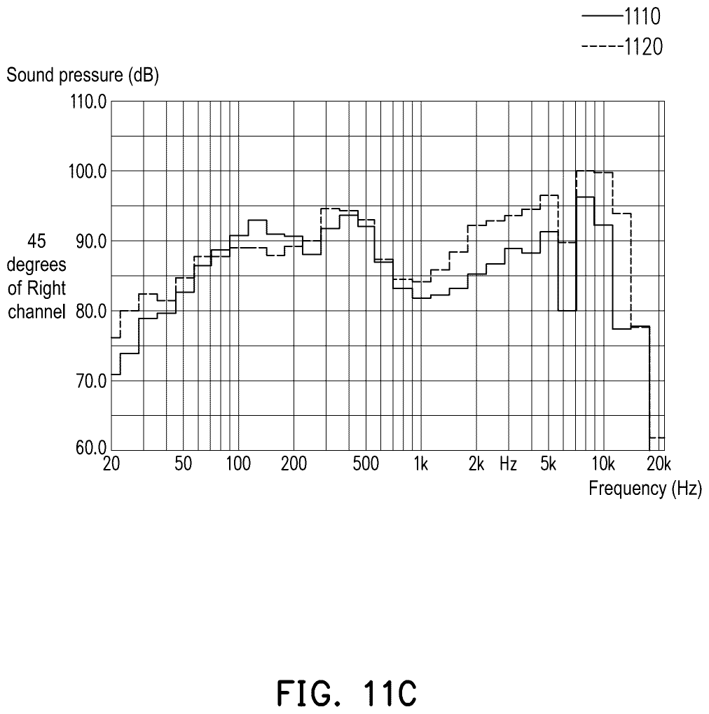

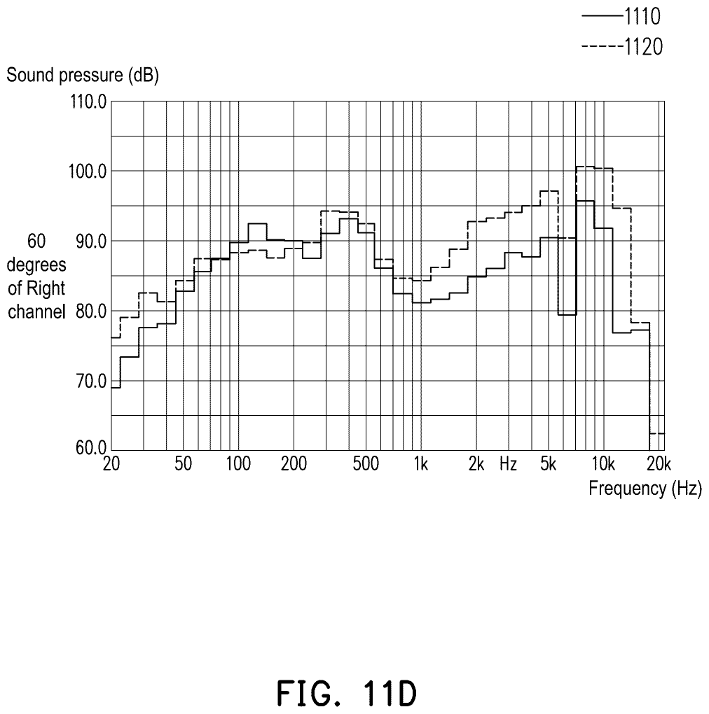

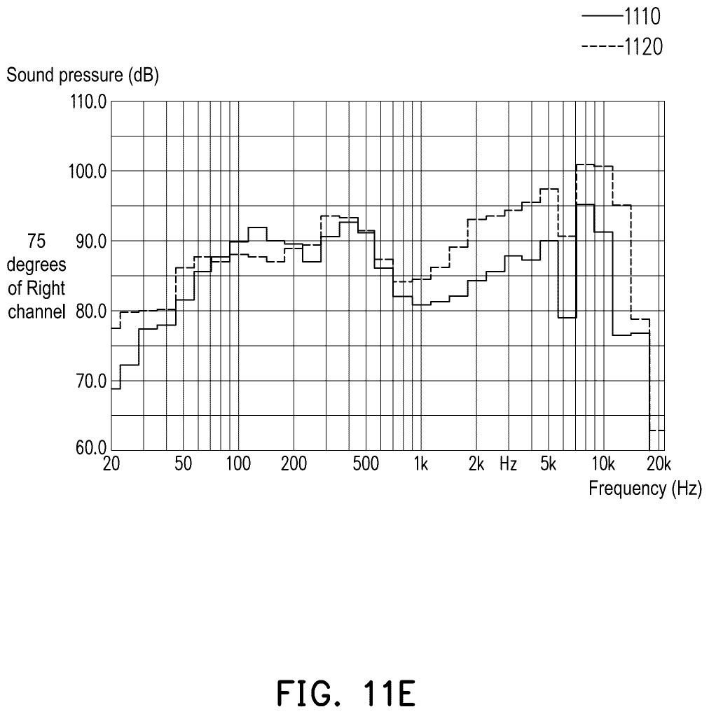

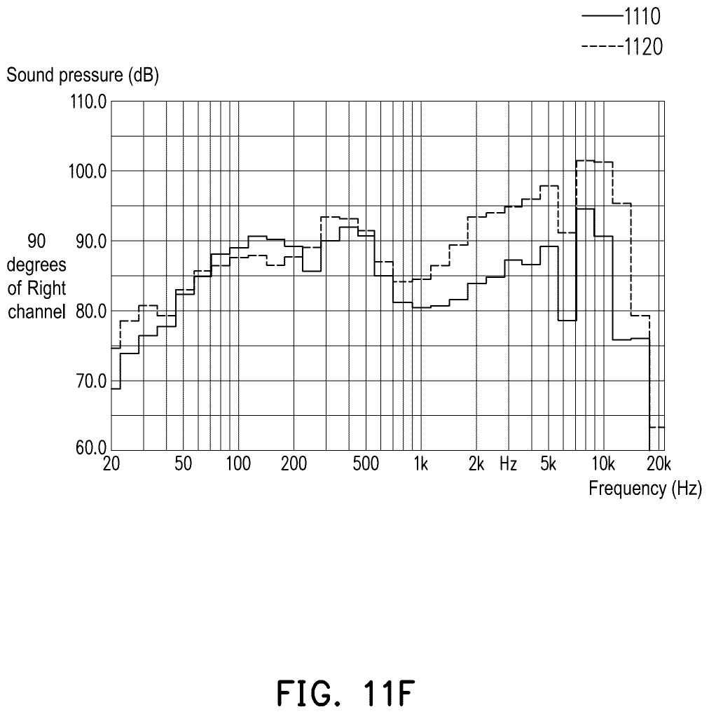

FIG. 11A to FIG. 11F are frequency response diagrams illustrating a right channel at different angles according to an embodiment of the disclosure. Please refer to FIG. 11A to FIG. 11F, which are the frequency response 1110 (the same as the frequency response 920 in FIG. 9A) when the orientation of the head is 0 degrees and the frequency response 1120 of the adjusted sound signal for the right channel when the orientations of the head are 15 degrees, 30 degrees, 45 degrees, 60 degrees, 75 degrees, and 90 degrees respectively.

It can be seen from FIG. 10A to FIG. 10F and FIG. 11A to FIG. 11F that the actual measurement results are consistent with the theory. In addition, the greater the change in the rotation angle/posture of the head, the more obvious (the greater the difference in sound pressure as shown in the figures) the impact of the sound field change on the sound signal in the high frequency band (for example, 2 K to 10 K Hz).

In summary, in the audio effect adjustment method and the computing apparatus used for the audio effect adjustment according to the embodiments of the disclosure, the sound source direction of the sound signal is detected, the modified orientation corresponding to the rotation of the head is determined according to the sound source direction, and the sound characteristics of the sound signal (for example, imparting the spatial or other audio effects) is adjusted according to the sound source direction and the modified orientation. Thereby, appropriate audio effects are provided and the listening experience is enhanced.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An audio effect adjustment method, adaptable for a processor implementation, the audio effect adjustment method comprising:
determining a sound source direction corresponding to sound characteristics of a sound signal, wherein the sound characteristics are related to at least one of an amplitude and a phase of the sound signal, and the sound signal is recorded from a sound source located in the sound source direction;
determining posture changes of a head, wherein the posture changes include a rotation angle of the head from a first orientation to a second orientation, and the head is used for wearing a sound playing apparatus; and
adjusting the sound characteristics of the sound signal according to a direction difference between the sound source direction and the second orientation, wherein the direction difference is an angle between the sound source direction and the modified second orientation, the modified second orientation is an orientation after the posture changes from the sound source direction, and the adjusted sound signal is used to be played by the sound playing apparatus.

2. The audio effect adjustment method according to claim 1, wherein the sound characteristics include a frequency response, the frequency response is a corresponding amplitude of the sound signal at a plurality of frequencies, and the step of adjusting the sound characteristics of the sound signal according to the direction difference between the sound source direction and the second orientation comprises:
adjusting the frequency response of the sound signal by a first parameter of an equalizer, wherein the sound source direction corresponds to a second parameter of the equalizer, the modified second orientation corresponds to a third parameter of the equalizer, the first parameter, the second parameter, the third parameter have corresponding gains at the plurality of frequencies, and the first parameter is a gain difference between the second parameter and the third parameter at the plurality of frequencies.

3. The audio effect adjustment method according to claim 1, wherein the sound characteristics comprise a signal delay, the signal delay is a time difference between sound signals of two channels, and the step of adjusting the sound characteristics of the sound signal according to the direction difference between the sound source direction and the second orientation comprises:
adjusting the signal delay of the sound signals of the two channels to a modified delay, the modified delay is a difference between a first delay and a second delay, the sound source direction corresponds to the first delay, and the modified second orientation corresponds to the second delay.

4. The audio effect adjustment method according to claim 1, wherein the step of determining the sound source direction corresponding to the sound characteristics of the sound signal comprises:
determining, by inputting the sound characteristics of the sound signal to a direction identification model, the sound source direction by the direction identification model, wherein the direction identification model is trained through a machine learning algorithm to learn an association between a reference sound source located in a plurality of reference directions and corresponding sound characteristics.

5. The audio effect adjustment method according to claim 1, wherein the step of determining the posture changes of the head comprises:
identifying the posture changes according to a plurality of head images, wherein the plurality of head images are images captured by rotating the head from the first orientation to the second orientation.

6. The audio effect adjustment method according to claim 5, wherein the step of identifying the posture changes according to the plurality of head images comprises:
identifying a face of the head image;
defining a feature point of the face; and
tracking a position of the feature point of the plurality of head images, wherein the posture changes are reflected in changes in the position of the feature point.

7. The audio effect adjustment method according to claim 1, further comprising:
transferring the sound signals of two channels to a surround sound field with a plurality of virtual speakers;
adjusting a frequency response and a phase from a plurality of directions corresponding to the plurality of virtual speakers based on a head related transfer functions (HRTF) theory; and
transferring the adjusted sound signal back to stereo sound field signals of the two channels.

8. The audio effect adjustment method according to claim 1, wherein the step of adjusting the sound characteristics of the sound signal according to the direction difference between the sound source direction and the second orientation comprises:
decreasing a parameter of the sound signal of a right channel at the first frequency in response to an increase in a parameter of the sound signal of a left channel at the first frequency, and increasing a parameter of the sound signal of the right channel at the second frequency in response to a decrease in a parameter of the sound signal of the left channel at the second frequency; or
decreasing a parameter of the sound signal of the left channel at the third frequency in response to an increase in a parameter of the sound signal of the right channel at the third frequency, and increasing a parameter of the sound signal of the left channel at the fourth frequency in response to a decrease in a parameter of the sound signal of the right channel at the fourth frequency.

9. A computing apparatus, used for an audio effect adjustment, comprising:
a storage, used to store a program code; and
a processor, coupled to the storage and configured to:
determine a sound source direction corresponding to sound characteristics of a sound signal, wherein the sound characteristics are related to at least one of an amplitude and a phase of the sound signal, and the sound signal is recorded from a sound source located in the sound source direction;
determine posture changes of a head, wherein the posture changes include a rotation angle of the head from a first orientation to a second orientation, and the head is used for wearing a sound playing apparatus; and
adjust the sound characteristics of the sound signal according to a direction difference between the sound source direction and the second orientation, wherein the direction difference is an angle between the sound source direction and the modified second orientation, the modified second orientation is an orientation after the posture changes from the sound source direction, and the adjusted sound signal is used to be played by the sound playing apparatus.

10. The computing apparatus, used for the audio effect adjustment according to claim 9, wherein the sound characteristics include a frequency response, the frequency response is a corresponding amplitude of the sound signal at a plurality of frequencies, and the processor is further configured to:
adjust the frequency response of the sound signal by a first parameter of an equalizer, the sound source direction corresponds to a second parameter of the equalizer, the modified second orientation corresponds to a third parameter of the equalizer, the first parameter, the second parameter, and the third parameter have corresponding gains at the plurality of frequencies, and the first parameter is a gain difference between the second parameter and the third parameter at the plurality of frequencies.

11. The computing apparatus, used for the audio effect adjustment according to claim 9, wherein the sound characteristics include a signal delay, the signal delay is a time difference between sound signals of two channels, and the processor is further configured to:
adjust the signal delay of the sound signals of the two channels to a modified delay, the modified delay is a difference between a first delay and a second delay, the sound source direction corresponds to the first delay, and the modified second orientation corresponds to the second delay.

12. The computing apparatus, used for the audio effect adjustment according to claim 9, wherein the processor is further configured to:
determine, by inputting the sound characteristics of the sound signal to a direction identification model, the sound source direction by the direction identification model, wherein the direction identification model is trained through a machine learning algorithm to learn an association between a reference sound source located in a plurality of reference directions and corresponding sound characteristics.

13. The computing apparatus used for the audio effect adjustment according to claim 9, wherein the processor is further configured to:
identify the posture changes according to a plurality of head images, wherein the plurality of head images are images captured by rotating the head from the first orientation to the second orientation.

14. The computing apparatus used for the audio effect adjustment according to claim 13, wherein the processor is further configured to:
identify a face of the head image;
define a feature point of the face; and
track a position of the feature point of the plurality of head images, wherein the posture changes are reflected in changes in the position of the feature point.

15. The computing apparatus used for the audio effect adjustment according to claim 9, wherein the processor is further configured to:
transfer the sound signals of two channels to a surround sound field with a plurality of virtual speakers;
adjust a frequency response and a phase from a plurality of directions corresponding to the plurality of virtual speakers based on a head related transfer functions (HRTF) theory; and
transfer the adjusted sound signal back to stereo sound field signals of the two channels.

16. The computing apparatus used for the audio effect adjustment according to claim 9, wherein the processor is further configured to:
decrease a parameter of the sound signal of a right channel at the first frequency in response to an increase in a parameter of the sound signal of a left channel at the first frequency, and increase a parameter of the sound signal of the right channel at the second frequency in response to a decrease in a parameter of the sound signal of the left channel at the second frequency; or
decrease a parameter of the sound signal of the left channel at the third frequency in response to an increase in a parameter of the sound signal of the right channel at the third frequency, and increase a parameter of the sound signal of the left channel at the fourth frequency in response to a decrease in a parameter of the sound signal of the right channel at the fourth frequency.
